(19) United States
(12) Patent Application Publication
(10) Pub. No.: US 2009/0124243 A1
(43) Pub. Date: May 14, 2009

(54) Methods, Apparatuses, Computer Program Products, And Systems For Providing Proximity/Location-Based Ringing Tones

(75) Inventors: James Routley, Backwell (GB); Mikko Nurmi, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/939,939

(22) Filed: Nov. 14, 2007

(51) Int. Cl. H04M 3/00; H04Q 7/20

(52) U.S. Cl. 455/418; 455/456.1; 455/466

(57) ABSTRACT

An apparatus for providing a proximity or location-based ringing tone may include a processor. The processor may be configured to receive an indication of a communication between a sender device and a recipient device along with location data indicating a location of the sender device, identify ringing tone settings based upon the location data, and announcing receipt of the indication of communication in accordance with the identified ring settings. Corresponding methods, systems, and computer program products are also provided.

### TECHNOLOGICAL FIELD

Embodiments of the present invention relate generally to mobile communication technology and, more particularly, relate to methods, apparatuses, computer program products, and systems for annunciating an incoming communication through location or proximity based ringing tones.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the ease of information transfer and convenience to users involves the provision of calling features. Call annunciation is an example of such a feature. It is currently common for mobile terminals, such as mobile telephones, to offer various different ringing tones which may be selected by users of the mobile terminals according to individual preferences. However, beyond the provision of conventional audio ringing tones, there is a current demand to provide more personalized calling features including call annunciation. In this regard, methods have been proposed in which, when a mobile terminal receives a call from a particular caller that is individually associated with a ringing tone, the ringing tone may be annunciated to alert the user of the mobile terminal of the call.

However, existing modes of call annunciation only allow a user to set preferences for ringing tones based on the identity of a particular caller. Although the use of different ringing tones for different callers does provide some information, a number of calls are generally received by a mobile terminal that are not originated by a person associated with a particular ringing tone. As such, the ability of a user to ascertain information regarding a calling party prior to answering the call in order to make a decision about the priority to be given to answering the call is limited without first looking at the calling number displayed on the display screen of the mobile device.

Accordingly, it may be advantageous to provide users with improved call annunciation tools, which may provide additional information regarding the calling party, thereby addressing at least some of the disadvantages described above.

### BRIEF SUMMARY

A method, apparatus, computer program product, and system are therefore provided to enable a user of a receiving device to differentiate callers based on a location of the sending device. In particular, a method, apparatus, computer program product, and system are provided to enable, for example, a user of a receiving device to define ringing tone settings for communications based on the location from which they originated. In this regard, the ringing tone annunciated by the receiving device may be determined based on the location of the sending device. As such, the user may define a plurality of ringing tone settings on his device and associate those settings with certain location parameters. Accordingly, user experience may be enhanced by enabling users to define ringing tone settings based on the location of the calling party.

In one exemplary embodiment, a method of providing a location or proximity-based ringing tone is provided. The method may include receiving an indication of a communication between a sender device and a receiver device and, in response to receipt of the indication, using the location of the sender device to annunciate a ringing tone with parameters predetermined by the user of the receiver device.

In another exemplary embodiment, a computer program product for providing location or proximity based ringing tones is provided. The computer program product includes at least one computer-readable storage medium having computer-readable program code portions stored therein. The computer-readable program code portions include first, second and third executable portions. The first executable portion is for receiving an indication of a communication from a sender device as well as location data indicating a position of the sender device. The second executable portion is for identifying ringing tone settings based upon the location data. The third executable portion is for, in response to receipt of the indication, announcing the communication in accordance with the identified ring settings.

In another exemplary embodiment, an apparatus for providing location or proximity based ringing tones is provided. The apparatus may include a processor. The processor may be configured to receive a communication from a sender device as well as location data indicating a location of the sender device, identify ring settings based upon the location data, and announce receipt of the communication in accordance with the identified ring settings.

In another exemplary embodiment, an apparatus for providing location or proximity based ringing tones is provided. The apparatus may include means for receiving a communication from a sender device as well as location data indicating a position of the sender device, means for identifying ring settings based upon the location data, and means for announcing receipt of the communication in accordance with the identified ring settings.

In another exemplary embodiment, a system for providing location or proximity based ringing tones is provided. The system may include a sender device configured to send a communication; a communications network configured to receive and route the communication from the sender device, wherein at lest one of the sender device and the communications network ascertain a location of the sender device and transmit that location data along with the communication to a receiver device; and a receiver device configured to receive a communication along with location data and to announce receipt of the communication with a ringing tone based upon the location data.

Embodiments of the invention may therefore provide a method, apparatus, computer program product, and system to enhance user experience during mobile communications. As a result, for example, users may benefit from using mobile terminals and other electronic devices with improved ability to determine information about the sender device, such as its location or proximity, prior to answering the communication.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing location or proximity based ringing tones according to an exemplary embodiment of the present invention;

FIG. 4 is a flowchart according to an exemplary method for providing location-based ringing tones according to an exemplary embodiment of the present invention; and

FIG. 5 is a flowchart according to an exemplary method for providing proximity-based ringing tones according to another exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

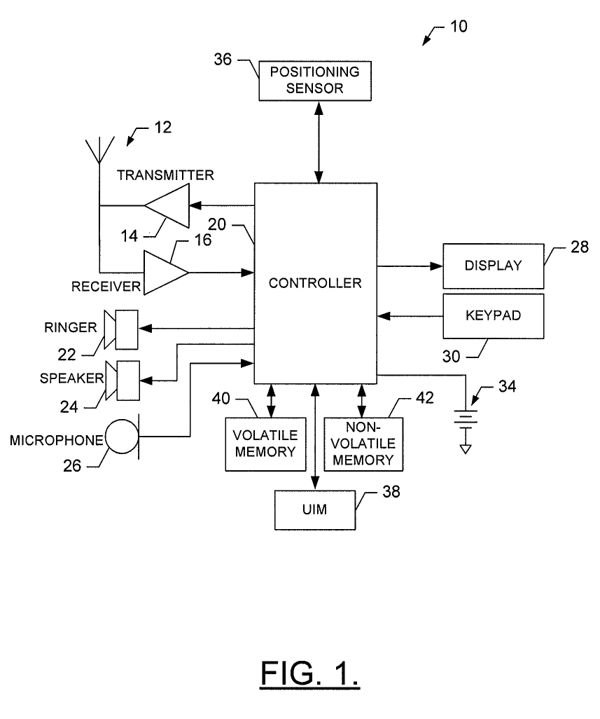

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a processor, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes means, such as circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may include a positioning sensor 36. The positioning sensor 36 may include, for example, a global positioning system (GPS) sensor, an assisted global positioning system (Assisted-GPS) sensor, etc. In one embodiment, however, the positioning sensor includes a pedometer or inertial sensor. Further, the positioning sensor may determine the location of the mobile terminal based upon signal triangulation or other mechanisms. The positioning sensor is capable of determining a location of the mobile terminal, such as latitude and longitude coordinates of the mobile terminal or a position relative to a reference point such as a destination or a start point. Information from the positioning sensor may be communicated to a memory of the mobile terminal or to another memory device to be stored as a position history or location information. Furthermore, the memory of the mobile terminal may store instructions for determining cell id information. In this regard, the memory may store an application program for execution by the controller 20, which determines an identity of the current cell, i.e., cell id identity or cell id information, with which the mobile terminal is in communication. In conjunction with the positioning sensor, the cell id information may be used to more accurately determine a location of the mobile terminal.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

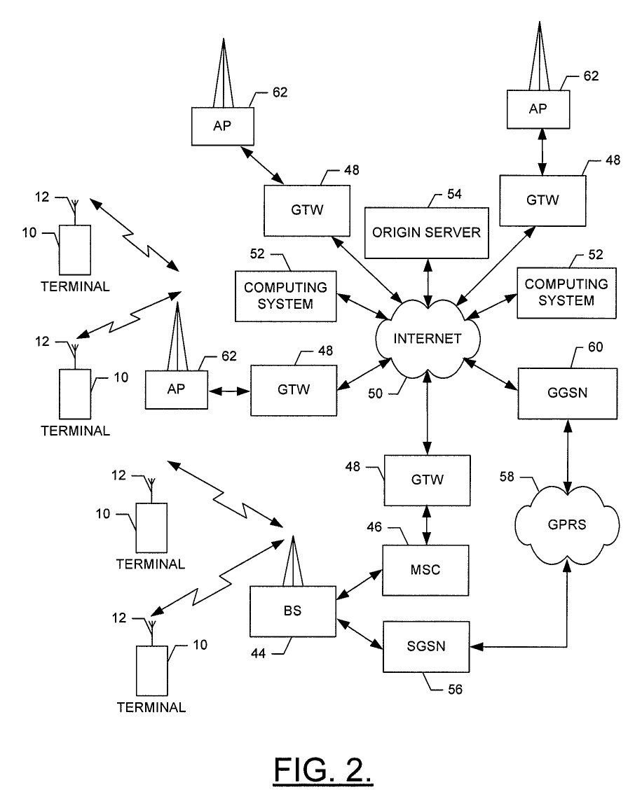

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1 and a network device of the system of FIG. 2 in order to execute applications for establishing communication between the mobile terminal 10 and other mobile terminals, for example, via the system of FIG. 2. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a network device such as a server or other device accessible to the communication device.

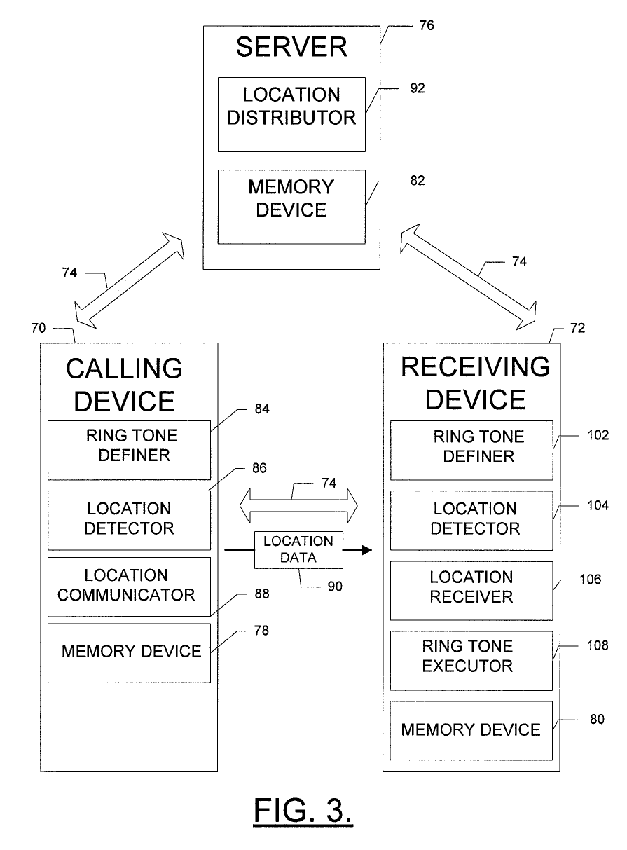

FIG. 3 illustrates a block diagram of a system for providing location-based ringing tones according to an exemplary embodiment of the present invention. The system of FIG. 3 will be described, for purposes of example, in connection with the mobile terminal 10 of FIG. 1. However, it should be noted that the system of FIG. 3, may also be employed in connection with a variety of other devices, both mobile and fixed, and therefore, embodiments of the present invention should not be limited to application on devices such as the mobile terminal 10 of FIG. 1. It should also be noted, that while FIG. 3 illustrates one example of a configuration of a system for providing location-based ringing tones, numerous other configurations may also be used to implement embodiments of the present invention.

Referring now to FIG. 3, a basic block diagram is depicted of a system for providing location-based ringing tones. As indicated in FIG. 3, the system may include a calling or sender device 70 and a receiving device 72, which may be capable of communication with each other via communication links 74. It should be understood that the communication links 74 may be provided by any suitable mechanism such as, for example, by the system of FIG. 2. In other words, in one exemplary embodiment, the calling device 70 and the receiving device 72 may each be mobile terminals (e.g., the mobile terminal 10) in communication via a cellular network. In an exemplary embodiment, the system may further include a server 76, which may be a computing device 52 or other network entity of the system of FIG. 2. The server 76 may be capable of communication with the calling device 70 and/or the receiving device 72 via the communication links 74. Each of the calling device 70, the receiving device 72 and the server 76 may include a corresponding memory device (e.g., memory device 78, memory device 80 and memory device 82, respectively).

Embodiments of the present invention may provide the receiving device 72 with the ability to define the ringing tone to be annunciated at the receiving device 72 upon receipt of a communication from the calling device 70 based on the location of the calling device 70 through the use of a ring tone definer 102. It should be appreciated that “communication” as used herein is not limited to voice calls, and may include other means of communication such as SMS messages, MMS messages, instant messages (IM), or e-mail. In an exemplary embodiment of the invention, the calling device 70 has a location detector 86, such as the positioning sensor 36 of the mobile terminal 10, which may be any device or means embodied in either hardware, software, or a combination of hardware and software that is configured to determine the approximate location of the device through any of several location detection techniques, including but not limited to, GPS, assisted GPS (AGPS), near field radio technologies, or operator network as well as other techniques mentioned herein in connection with the above description of the positioning sensor 36. The location detector 86 may be controlled by or otherwise embodied as the processor, such as for example the controller 20, of the calling device 70. Although the location detector 86 is discussed herein as embodied as a component of a mobile terminal 10, it is important to note that the location detector 86 may in alternative embodiments also be embodied in hardware, software, or a combination of hardware and software on a separate or remote device in communication with the calling device 70, such as any device of the system of FIG. 2.

The calling device 70 has a location communicator 88, which enables the calling device 70 to communicate its location data 90, as determined by the location detector 86 to define the locator of the calling device, to the receiving device 72. The location data 90 may take various forms including the position of the calling device, the area code of the calling device, or the proximity of the calling device to the receiving device as described below. In this regard, the calling device 70 may either communicate its location data 90 directly to the receiving device 72 via the communication links 74, or the calling device 70 may communicate the location information 90 to the receiving device 72 indirectly via the server 76 or another device via the communication links 74. It should be appreciated, however, that embodiments of the present invention are not limited to embodiments where the calling device 70 determines and communicates its own location, as in other embodiments the location of the calling device 70 may be determined by the server 76 or other network devices of the system of FIG. 2, such that the location detector may be alternatively embodied by the server or other network device.

The location communicator 88 of calling device 70 may be any device or means embodied in either hardware, software, or a combination of hardware and software that is configured to communicate the location data 90 of the calling device 70 to another device such as, for example, the server 76 or the receiving device 72. In this regard, the location communicator 88, which may be controlled by or otherwise embodied as the processor, such as for example the controller 20, of the calling device 70, may, for example, packetize the location data 90 as determined and relayed by the location detector 86 for communication via the communication links 74. As such, the location communicator 88 may be configured to enable streaming of the location data 90, or the location communicator 88 may be configured to communicate the location data 90 to either the receiving device 72 or the server 76 for storage via a bursty communication mechanism using the communication links 74.

In alternative embodiments the server 76 stores a plurality of location data 90 of mobile devices 10 in communication with the systems of FIG. 2 and FIG. 3. The separate location data 90 may be organized and/or identified in a manner to associate a location with a corresponding mobile device. As such, the server 76 may be configured to store (e.g., in the memory device 82) a plurality of location data 90 for different respective calling devices and deliver a selected one of the plurality of location data 90 to the receiving device 72 based on instructions from a location distributor 92 that may be included in, or otherwise in communication with, the server 76. The server 76 may deliver the selected location data 90 to the receiving device 72 either in response to a communication directed to the receiving device 72, in turn forwarding the location data 90 of the calling device 78 along with the communication. Alternatively, the location distributor 92 may be configured to periodically distribute location data 90 corresponding to one or more devices, e.g., mobile terminals, associated with the individuals included in a contacts or other list contained in memory device 80 of the receiving device 72. In this alternative embodiment, the receiving device may therefore already have stored in it memory device the relevant location data when a call is received from a device associated with a user who is in the contacts list of the receiving device.

The location distributor 92 may be any device or means embodied in either hardware, software, or a combination of hardware and software that is configured to manage the communication of location data 90 to other devices. In this regard, for example, the location data 90 may include, in addition to the location information, execution information defining to which device and/or under which circumstances location information is to be communicated. For example, the location data 90 may be stored in the memory device 82 and the execution information may define that, in response to a call being placed between the calling device 70 and the receiving device 72, the location data 90 is to be streamed to the receiving device 72. Alternatively, the execution information may define that the location data 90 is to be communicated to the receiving device 72 in a manner other than by streaming (e.g., by burst transmission), for example, at a predetermined time, at the first available opportunity, or in response to a communication being placed between the calling device 70 and the receiving device 72. As another alternative, the execution information could include an identification of one or more users (e.g., one or multiple receiving devices in, for example, a contacts list) to which the location data 90 should be communicated and at which the location data 90 should be stored. The location distributor 92 may be controlled by or otherwise embodied as a processor of the server 76 to distribute or otherwise communicate the location data 90 in response to instructions to do so or in response to the fulfillment of conditions that define a trigger for communication of the location data 90.

In an exemplary embodiment, the receiving device 72 may include a ring tone definer 102, which may be any device or means embodied in either hardware, software, or a combination of hardware and software that is configured to define ring tone settings for communications based on the location from which the communication originated. The ring tone definer 102 may be embodied as, or otherwise controlled by a processor (e.g., the controller 20) of the receiving device 72. Processor(s) as described herein may be embodied in many ways. For example, the processor may be embodied as a microprocessor, a coprocessor, a controller or various other processing means or devices including integrated circuits such as, for example, an ASIC (application specific integrated circuit). The ring tone definer 102 may present a user of the receiving device 72 with various options, such as via a menu, list or other format, that may be manipulated or selected by a user interface of the receiving device 72 for defining location-based ring settings. The location-based ring settings may be stored in the memory device 80 of the receiving device 72 and, for example, if activated in response to receipt of a communication from the calling device 70, selected or otherwise executed at the receiving device 72, the location-based ring settings may modify or otherwise control elements of audio, vibration, or other ringing settings of the receiving device 72.

The receiving device 72 may include a location receiver 106, which may be any device or means embodied in either hardware, software, or a combination of hardware and software that is configured to receive (e.g., via stream or burst) the location data 90 and store or forward the location data 90 directly to a ring tone executor 108. The location receiver 106 of one embodiment may further be configured to determine an approximate location of the calling device 70 based on the mode of communication link 74 used by the calling device 70 to send a communication to the receiving device 72. This configuration is particularly useful for proximity-based near field radio technologies, such as Bluetooth, where the receipt of a communication by the particular proximity-based technology indicates that the calling device 70 is within a proximity limited by the range of the respective communication mode. The location receiver 106 may be controlled by or otherwise embodied as a processor (e.g., the controller 20) of the receiving device 72. In response to receipt of the location data 90, the location receiver 106 may be configured to store the location data 90 in the memory device 80 in association with the calling device 70, such as in association with the appropriate contact designating the calling device 70 if there is not currently an active communication between the receiving device 72 and the calling device 70. In embodiments in which the receiving device obtains and stores location data for the electronic devices associated with one or more users who may later desire to communicate with the receiving device, the location receiver 106 may periodically obtain location data 90 from server 76 for all of the potential calling devices 70 in the receiving device's 72 contact list and store that periodically updated location data 90 in association with the appropriate calling device 70 in memory device 80. As another alternative, the receiving device 72 may itself store such location data 90 at the server 76 and access the location data 90 when a communication is sent from the calling device 70 to the receiving device 72. Accordingly, the location data 90 may be stored (e.g., in the memory device 80 or 82) in association with an identification of the corresponding calling device 70 to enable identification of conditions requiring execution of a ring tone at the receiving device 72 (e.g., when the receiving device 72 receives a communication from the calling device 70).

In an exemplary embodiment, the receiving device 72 is further equipped with a ring tone executor 108, which may be any device or means embodied in either hardware, software, or a combination of hardware and software that is configured to in response to receipt of a communication from a calling device 70 to receive the location data 90 associated with the calling device 70 from the location receiver 106 or to look up stored location data 90 associated with that calling device 70 in memory device 80. The location data 90 is then compared to location-based ringing tone settings stored in memory device 80 to determine if the location data 90 satisfies the location parameters associated with any one of a plurality of location-based ringing tone settings and, if so, the matching location-based ringing tone settings are annunciated by the ring tone executor 108. The ring tone executor 108 may be controlled by or otherwise embodied as a processor, such as the controller 20, of the receiving device 72.

In such an exemplary embodiment, a user of a receiving device 72 in, for example, the United States may have work contacts in, for example, Finland. As such a user of a receiving device 72 may wish to note all calls originating from a calling device 70 located in Finland with a particular ringing tone. Thus a user of a receiving device 72 may set all calls originating from a calling device 70 located in Finland to be annunciated at a louder volume with a particular ringing tone along with vibration to ensure that he accords the proper priority in answering a call from a potential professional associate. The same user of a receiving device 72 may also have family in a particular region. As such, a user of a receiving device 72 may set all calls originating from a calling device 70 located in that region to be annunciated at a volume lower than that of calls originating from a calling device 70 located in Finland with a different ringing tune that is of some personal importance to the user's family and no vibration.

While the location data 90 associated with the calling device 70 may be sufficient to drive the ring tone executor 108 in a number of embodiments, other embodiments rely upon a difference between the location data 90 of the calling device 70 and the receiving device 72 to drive the ring tone executor 108. In these other embodiments, the receiving device 72 may further be equipped with a location detector 104, such as the positioning sensor 36 of the mobile terminal 10, which may be any device or means embodied in either hardware, software, or a combination of hardware and software that is configured to determine the location of the receiving device either in absolute terms or relative to the calling device 70, such as through GPS, AGPs, near field radio technology, communication from a cell tower or server 76, or other means, and to store the location of the receiving device 72 in memory device 80 or to forward the location of the receiving device 72 directly to the ring tone executor 108. The location detector 104 may be controlled by or otherwise embodied as a processing element (e.g., the controller 20) of the receiving device 72. Although the location detector 104 is discussed herein as embodied as a component of a mobile terminal 10, it is important to note that in alternative embodiments the location detector 104 may also be embodied in hardware, software, or a combination of hardware and software on a separate or remote device in communication with the receiving device 72, such as any device of the system of FIG. 2. The location detector 104 may determine the location of the receiving device 72 in response to an incoming communication from a calling device 70, or the location detector 104 may determine the location of the receiving device in advance, such as, repeatedly or periodically. The location of the receiving device 72 as determined by the location detector 104 is then passed to the ring tone executor 108, which then uses the location of the receiving device 72 and the location data 90 associated with the calling device 70 to determine the proximity of the receiving device 72 to the calling device 70. That proximity may then be compared to location-based ringing tone settings stored in memory device 80 and if the determined proximity falls within a proximity range parameter associated with any one of a plurality of location-based ringing tone settings then the matching location-based ringing tone settings are rendered by the ring tone executor 108. It should be appreciated, however, that embodiments of the present invention are not limited to embodiments where the receiving device 72 determines its own location, as in other embodiments the location of the receiving device 72 may be determined by the server 76 or other network devices of the system of FIG. 2, such that the location detector may be alternatively embodied by the server or other network device and the location of the receiving device 72 is communicated to the receiving device 72 by a remote network device.

In an exemplary embodiment, the ring tone executor 108 may additionally be configured to determine the direction in which the calling device 70 is positioned relative to the position of the receiving device 72 using the location data 90 associated with the calling device 70. If the speaker 24 of the receiving device 72 has surround sound capability, the ringing tone sound could come from the direction of the calling device 70 to give an audible indication of the direction. Additionally, or alternatively, if at least one of the calling device 70 and the receiving device 72 is moving while a call is in progress but not yet answered by the receiving device 72, the ringing tone's frequency could be altered to give an audible indication of whether the devices are moving toward each other or away from each other. This audible indication would be similar to the Doppler Effect heard as an ambulance with an active siren approaches and passes by an individual. Visual indication could also be given alternatively, or in addition in other exemplary embodiments as the display 28 could display a graphic indication of the direction of the calling device 70. The display 28 may also be used to display the location of the calling device 70 and/or the distance of the calling device 70 from the receiving device 72 as determined by the ring tone executor 108.

It should be appreciated that location-based ringing tones are not limited to the user of a receiving device 72 defining ringing tone settings to be annunciated in response to incoming communications on the receiving device based on a location of the calling device 70. Aspects of the invention also allow a user of the calling device 70 to specify the annunciation of his communication to the receiving device 72 based on a location or proximity of the receiving device 72. In an exemplary embodiment, the calling device 70 has a ring tone definer 84, which may be any device or means embodied in either hardware, software, or a combination of hardware and software that is configured to define ringing tone settings for communications based on the location of the receiving device 72. The ring tone definer 84 may be embodied as, or otherwise controlled by a processing element (e.g., the controller 20) of the calling device 70. The ring tone definer 84 may present a user of the calling device 70 with various options, such as via a menu, list or other format, that may be manipulated or selected by a user interface of the calling device 70 for defining location-based ringing tone settings. The location-based ringing tone settings may be stored in the memory device 78 of the calling device 70 and, for example, if activated in response to initiation of a communication from the calling device 70 to a receiving device 72 in a location falling within the parameters of a location-based ringing tone setting stored in memory device 78, transmitted to and selected or otherwise executed at the receiving device 72 so as to modify or define elements of audio, vibration, or other ringing tone settings of the receiving device 72.

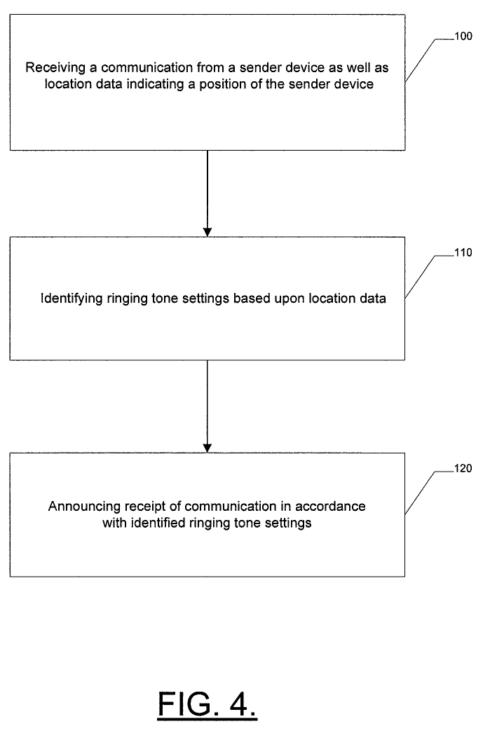

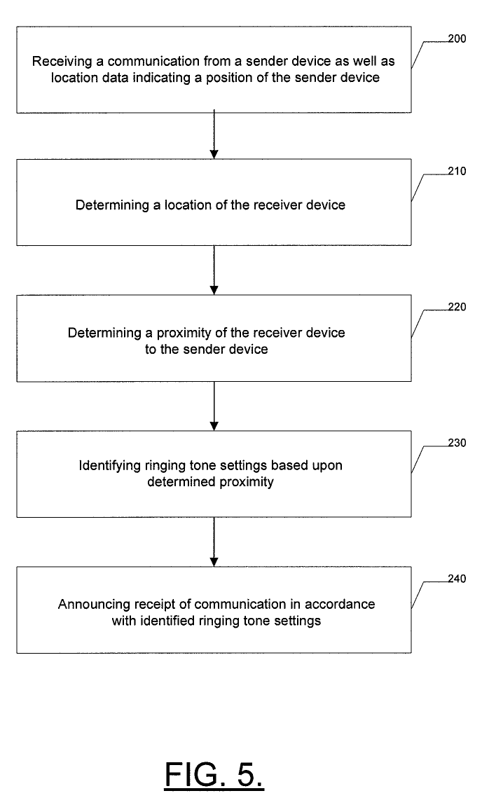

FIGS. 4 and 5 are flowcharts of a system, method, and computer program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing location-based ringing tones as illustrated in FIG. 4 may include receiving a communication from a sender device as well as location data indicating a position of the sender device at operation 100. In an exemplary embodiment, the communication may be a phone call, a short message service (SMS) message, a multimedia messaging service (MMS) message, an instant message (IM), or an e-mail. In an exemplary embodiment, the location data may comprise an indication of the position of the calling device, such as GPS coordinates; a realization that the communication was received by a proximity-based near-field communication technology, such as Bluetooth, where the receipt of a communication by the particular proximity-based technology indicates that the sender device is within a proximity limited by the range of the respective communication mode; or some other indicator of a country or a region of origin, such as a country code or area code included within the telephone number of the sender device. Ringing tone settings based upon the location data may be identified at operation 110. Operation 110 may include identifying a storage location of ringing tone settings and accessing the ringing tone settings. The identified storage location may be one of an external location (e.g., a memory device of a network device or server) or an internal location (a memory device of the receiving or initiating device). In response to receipt of the communication, the identified ringing tone settings may be annunciated at operation 120. In an exemplary embodiment, operation 120 may include executing ringing tone settings comprising instructions for modifying audible or vibration settings for annunciating receipt of a communication on a receiving device, such as to alter the volume of the ringing tone or to play a distinctive tune indicative of an incoming call from a particular location.

As an alternative to altering ringing tone settings based solely on the location of the sender device, the alteration of the ringing tone settings may be based on the proximity of the sender device to the receiving device. In this regard, one embodiment of a method of providing proximity-based ringing tones as illustrated in FIG. 5 may include receiving a communication from a sender device as well as location data indicating a position of the sender device at operation 200. In an exemplary embodiment, the communication may be a phone call, a short message service (SMS) message, a multimedia messaging service (MMS) message, an instant message (IM), or an e-mail. In an exemplary embodiment, the location data may comprise an indication of the position of the calling device, such as GPS coordinates; a realization that the communication was received by a proximity-based near-field communication technology, such as Bluetooth, where the receipt of a communication by the particular proximity-based technology indicates that the sender device is within a proximity limited by the range of the respective communication mode; or some other indicator of a country or a region of origin as noted above. The receiver device may determine its own location at operation 210. Operation 210 may determine a location through any of several well known techniques, including, but not limited to GPS, assisted GPS, or operator network as well as other techniques mentioned herein in connection with the above description of the positioning sensor 36. Operation 220 may determine a proximity of the receiver device to the sender device using the location data obtained from the sender device as well as the location determined for the receiving device. Ringing tone settings based upon the determined proximity may be identified at operation 230. Operation 230 may include identifying a storage location of ringing tone settings and accessing the ringing tone settings. The identified storage location may be one of an external location (e.g., a memory device of a network device or server) or an internal location (a memory device of the receiving or initiating device). In response to receipt of the communication, the identified ringing tone settings may be annunciated at operation 240. In an exemplary embodiment, operation 240 may include executing ringing tone settings comprising instructions for modifying audible or vibration settings for annunciating receipt of a communication on a receiving device.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to a user of a mobile terminal 10. For example, a user of a receiving device 72 may know that all calls originating from a certain location are either work or personal related and may not wish to be interrupted with those calls at a particular time. By enabling the user of a receiving device 72 to define location-based ringing tone settings with the ring tone definer 104 then the user may appropriately prioritize or ignore communications received from a calling device 70 which originate in a particular location. In a further example of advantages provided by at least some embodiments of the invention, users of mobile terminals 10 in close proximity to each other in, for example, a business meeting or a classroom, may wish to pass each other SMS messages without betraying their activity to others in the vicinity. By enabling the user of a receiving device 72 to define ringing tone settings based on the proximity of the calling device 70 with the ring tone definer 104, a user of a receiving device 72 may set ringing tone settings for SMS messages received from a calling device 70 in close proximity to silent.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving a communication from a sender device as well as location data indicating a position of the sender device;
identifying ringing tone settings based upon the location data; and
announcing receipt of the communication in accordance with the identified ringing tone settings.

2. A method according to claim 1, wherein the communication is received by a receiver device, and wherein identifying the ring settings comprises determining a location of the receiver device and determining a proximity of the receiver device to the sender device.

3. A method according to claim 1, wherein the communication comprises a phone call, a short message service (SMS) message, a multimedia messaging service (MMS) message, an instant message (IM), or an e-mail.

4. A method according to claim 1, wherein the location data comprises GPS coordinates, an indication of country or region, or receipt of a proximity-based communication.

5. A method according to claim 1, wherein identifying the ringing tone settings comprises accessing a respective ringing tone setting from among a plurality of pre-stored ringing tone settings.

6. A method according to claim 1, wherein announcing receipt of the communication in accordance with the identified ringing tone settings comprises modifying audible or vibration settings indicating receipt of a communication.

7. A method according to claim 1, further comprising indicating a direction in which the sender device is positioned relative to a receiving device through audible and/or visual means.

8. A method according to claim 1, wherein the communication is received by a receiver device, and wherein if at least one of the sender device and the receiver device is moving relative to the other while a communication is in progress a frequency of the ringing tone is altered to give an indication of whether the sender and receiver devices are moving closer to or farther away from each other.

9. A computer program product comprising at least one computer-readable storage medium having computer-readable program code portions stored therein, the computer-readable program code portions comprising:
a first executable portion for receiving an indication of a communication from a sender device as well as location data indicating a position of the sender device;
a second executable portion for identifying ringing tone settings based upon the location data; and
a third executable portion for announcing the communication in accordance with the identified ringing tone settings.

10. A computer program product according to claim 9, wherein the second executable portion includes instructions for determining a location of a receiver device and determining a proximity to the sender device

11. A computer program product according to claim 9, wherein the first executable portion includes instructions for receiving an indication of a phone call, a short message service (SMS) message, a multimedia messaging service (MMS) message, an instant message (IM), or an e-mail.

12. A computer program product according to claim 9, wherein the first executable portion includes instructions for receiving location data in the form of GPS coordinates, an indication of country or region, or receipt of a proximity-based communication.

13. A computer program product according to claim 9, wherein the third executable portion includes instructions for indicating a direction in which the sender device is positioned relative to a receiving device through audible and/or visual means.

14. A computer program product according to claim 9, wherein the third executable portion includes instructions for determining whether at least one of the sender device and a receiver device is moving relative to the other while a communication is in progress and if so, altering a frequency of the ringing tone to give an indication of whether the sender and receiver devices are moving closer to or farther away from each other.

15. An apparatus comprising a processor configured to:
receive a communication from a sender device as well as location data indicating a location of the sender device;
identify ringing tone settings based upon the location data; and
cause receipt of the communication to be announced in accordance with the identified ringing tone settings.

16. An apparatus according to claim 15, wherein the processor is further configured to determine a location of a receiver device and determine a proximity to the sender device.

17. An apparatus according to claim 15, wherein the processor is further configured to receive an indication of a phone call, a short message service (SMS) message, a multimedia messaging service (MMS) message, an instant message (IM), or an e-mail.

18. An apparatus according to claim 15, wherein the processor is further configured to receive location data in the form of GPS coordinates, an indication of country or region, or receipt of a proximity-based communication.

19. An apparatus according to claim 15, wherein the processor is further configured to identify the ringing tone settings by accessing a respective ringing tone setting from among a plurality of pre-stored ringing tone settings.

20. An apparatus according to claim 15, wherein the processor is further configured to announce receipt of the communication in accordance with the identified ringing tone settings by executing instructions for modifying audible or vibration settings indicating receipt of a communication.

21. An apparatus according to claim 15, wherein the processor is further configured to indicate a direction in which the sender device is positioned relative to a receiving device through audible and/or visual means.

22. An apparatus according to claim 15, wherein the processor is further configured to determine whether at least one of the sender device and a receiver device is moving relative to the other while a communication is in progress and if so to alter a frequency of the ringing tone to give an indication of whether the sender and receiver devices are moving closer to or farther away from each other.

23. A system comprising
a sender device configured to send a communication;
a communications network configured to receive and route the communication from the sending device, wherein at least one of the sender device and the communications network ascertain a location of the sender device; and
a receiver device configured to receive a communication along with data representative of the location of the sender and to announce receipt of the communication with a ringing tone based upon the location of the sender.

24. An apparatus comprising:
means for receiving a communication from a sender device as well as location data indicating a position of the sender device;
means for identifying ringing tone settings based upon the location data; and
means for announcing receipt of the communication in accordance with the identified ringing tone settings.

25. An apparatus according to claim 25, further comprising:
means for determining a location of a receiver device; and
means for determining a proximity of the receiver device to the sender device.
